(19) United States
(12) Patent Application Publication
(10) Pub. No.: US 2026/0252704 A1
(43) Pub. Date: Aug. 27, 2026

(54) SYSTEMS AND METHODS FOR DETERMINING AND OR RANKING CYBERSECURITY STRENGTH

(71) Applicant: TEACHERS INSURANCE AND ANNUITY ASSOCIATION OF AMERICA, NEW YORK, NY (US)

(72) Inventors: Upendra Mardikar, Fremont, CA (US); Ronald Barthel, Marvin, NC (US); Charles Hartley, Davidson, NC (US)

(21) Appl. No.: 19/060,369

(22) Filed: Feb. 21, 2025

(51) Int. Cl. G06F 21/57; G06F 21/55

(52) U.S. Cl. CPC G06F 21/577; G06F 21/552

(57) ABSTRACT

The following relates generally to a computer-implemented method for building a security score for a company, comprising receiving, via one or more processors, input data using an application programming interface (API); analyzing, via the one or more processors, the input data according to at least a first technique including applying weights to different vulnerabilities, wherein the weights are determined using an attention model and by biasing the security score towards vulnerabilities that are determined to be more critical by the attention model; determining, via the one or more processors, a security score based on the analysis; outputting, via the one or more processors, the security score; and updating, via the one or more processors, the analysis by collecting new input data using the API.

### FIELD

The present disclosure generally relates to methods and systems for evaluating an overall security posture for a company, and more particularly relates to building a security score for a company.

### BACKGROUND

An organization often must rely on third party vendor companies for many services, such as software, applications, data processing and analysis, artificial intelligence or other functions. Because of this, the organization is reliant on the vendor companies to implement robust cybersecurity practices, but often lack insight into the vendor company's security practices. Additionally, if the company is the victim of a cyberattack, it is the organization that suffers reputational harm.

Security posture management (SPM) refers to the process of continuously monitoring, assessing, and improving an organization's security status to ensure it can defend against threats, vulnerabilities, and attacks. It involves the collection and analysis of various data points related to an organization's cybersecurity infrastructure, such as security policies, practices, systems, and technologies. The goal is to identify and address weaknesses, ensure compliance with security standards, and improve resilience to potential risks. Elements of security posture management include risk assessment, standard compliance, threat intelligence, continuous monitoring, and security controls. Conventionally, security posture management has been applied to discrete elements of cyber security, such as related to cloud security, application security, data security, artificial intelligence security, software security, and the like.

In conventional methods for evaluating a vendor company's security practices, questionnaires are sent to the company to be filled out, generally related to a single security, such as those listed above. However, the questionnaires may be completed by a person who does not have a full picture of a company's security practices, and so may not provide full and complete answers. In addition, ongoing assessments of security practices may be difficult to obtain due to company's unwillingness to fill out further questionnaires.

For this reason, it is advantageous for an organization to be able to evaluate a vendor company's cybersecurity practices and risks that is automated, customizable, and ongoing before engaging with the company for any services.

### SUMMARY

The present embodiments may be related to evaluating security procedures and practices for vendor companies to organizations to make the best decision for which vendor company to engage for services. They may also facilitate risk management and assessment.

In one aspect, a computer-implemented method for building a security score for a company that evaluates the company using accurate data and objective methods may be provided. The data may be received from the company using an application programming interface (API) and analyzed with respect to various criteria, such as cloud security posture management (CSPM), SaaS security posture management (SSPM), data security posture management (DSPM), application security posture management (ASPM), artificial intelligence security posture management (AISPM), and/or other security posture management. The input data may then be analyzed using a weighting technique, where the weights are determined using an attention model and by biasing the security score towards vulnerabilities that are determined to be more critical by the attention model. The security score may then be output and updated by collecting new input data using the API.

The method may include additional, fewer, or alternate actions, including those discussed elsewhere herein.

In another aspect, a computer system configured for building a security score for a company may be provided. The computer system may include one or more local or remote processors which may be in wired or wireless communication with one another. For instance, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) receive input data using an application programming interface (API), (2) analyze the input data, (3) determine a security score based on the analysis, (4) output the security score, and (5) update the analysis by collecting new input data using the API. The input data may be analyzed using a first technique that includes applying weights to different vulnerabilities, where the weights may be determined using an attention model and by biasing the security score towards vulnerabilities that may be determined to be more critical by the attention model.

The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an example computing system in which various embodiments of the present disclosure may be implemented.

FIG. 2 depicts an example message screen of a company's security score that may be displayed.

FIG. 3 depicts an example message screen that displays a company's security score as a percent risk of facing a cybersecurity event.

FIGS. 4 and 5 depict example process flows for determining a security score, in accordance with various embodiments described herein.

### DETAILED DESCRIPTION

The present embodiments relate to, inter alia, determining a security score for a company that represents the risk associated with that company's security procedures and processes. The determined security score allows an organization to quantify the risk associated with working with a specific vendor company, such as using a vendor to provide software applications or cloud computing to the organization. The security score also provides the advantage of alerting a vendor company to potential weaknesses in their processes or procedures that may be exploited by a bad actor, allowing the vendor company to take proactive measures to fix any identified weak points. For example, a vendor company may receive a low security score due to its use of older software versions, which they might not have been aware of previously. This identified weakness can then be addressed by updating to more recent software versions or applying patches from the software developer. In turn, this can increase the vendor company's security score and enhance their reputation, making them more attractive to potential organizations for contracting.

### Exemplary Computer System

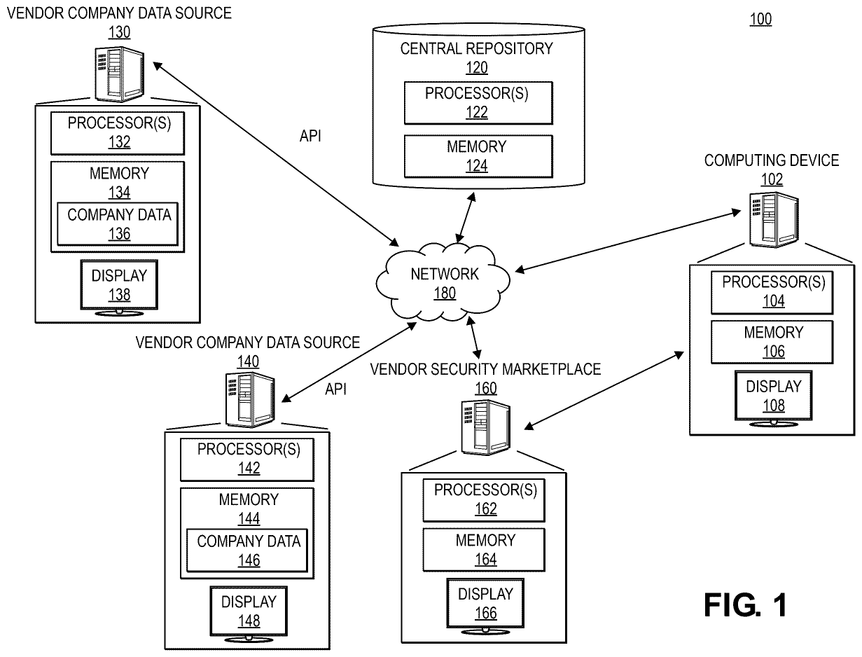

FIG. 1 illustrates an exemplary computer system 100 for building a security score in which the exemplary computer-implemented methods described herein may be implemented. The high-level architecture includes both hardware and software applications, as well as various data communications channels for communicating data between the various hardware and software components.

The computing device 102 may include one or more processors 104, such as one or more microprocessors, controllers, and/or any other suitable type of processor. The computing device 102 may further include a memory 106 (e.g., volatile memory, non-volatile memory) accessible by the one or more processors 104 (e.g., via a memory controller). The one or more processors 104 may interact with the memory 106 to obtain and execute, for example, computer-readable instructions stored in the memory 106. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 106 may include instructions for executing various applications. The computing device 102 may further include display 108.

An organization that owns the computing device 102 may receive services from a vendor company. For example, the organization may need cloud computing services, software as a Service (SaaS), applications, data management, or other services. To ensure that the organization is making a sound business decision and minimizing their risk of experiencing a cybersecurity event, the organization may wish to assess the security practices of a potential vendor company by analyzing data related to the vendor company's security practices, using the company data source 130 or 140. Of course, the number of companies that receive security scores is not limited and may be any number. The company data source 130 or 140 may be kept by a vendor company on a computing device and may include one or more processors 132 or 142, such as one or more microprocessors, controllers, and/or any other suitable type of processor. The computing devices 130 or 140 may further include a memory 134 or 144 (e.g., volatile memory, non-volatile memory) accessible by the one or more processors 132 or 142 (e.g., via a memory controller). The one or more processors 132 or 142 may interact with the respective memories 134 or 144 to obtain and execute, for example, computer-readable instructions stored in the memory 134 or 144. Additionally or alternatively, computer-readable instructions may be stored on one or more removable media (e.g., a compact disc, a digital versatile disc, removable flash memory, etc.) that may be coupled to the computing devices 130 or 140 to provide access to the computer-readable instructions stored thereon. In particular, the computer-readable instructions stored on memory 134 or 144 may include instructions for executing various applications. Company data 136 or 146 may also be stored on memory 134 or 144. The company data 136 or 146 may include any data related to security practices or procedures, such as software applications used, the software applications'version, password policies, access policies, or other security related information. The computing devices 130 or 140 may further include displays 138 or 148, respectively.

The company data 136 or 146 may be accessed through network 180, (which may be a wired or wireless network, such as the internet), using an application programming interface (API). The company data 136 or 146 may then be analyzed by the processor of computing device 102 or by a processor associated with another third-party computing device, such as security marketplace 160. The use of an API allows for the vendor company data 136, 146 to be updated and the analysis to be performed on a regular basis, such as time intervals of hours, days, months, or any regular interval, and irregular basis, such as after a vulnerability is discovered or exploited. In that case, it is desirable to perform an analysis using the knowledge of the vulnerability to assess a company's exposure to the vulnerability, which may affect the security score of the company. The analysis may also be performed on a continuous basis. Continuous analysis may be advantageous because a change in a company's security procedure may be quickly exploited by a bad actor. Advantageously, embodiments discussed herein may provide real-time, continuous updating of the security score(s). For instance, the example screens 200, 300 may be updated in real-time.

An API may be a connection between computers that use a software interface to allow applications to communicate with each other. Examples of APIs that may be used include: open APIs, partner APIs, private APIs, web APIs, and others. In that sense, APIs are an accessible way to extract and share data within and across organizations. In some examples, the API is provided by the vendor company and accessed by computing device 102 (e.g., owned by the organization that is evaluating the security of the vendor company) for analysis. In other examples, the API is provided by computing device 102 (e.g., owned by the organization that is evaluating the security of the vendor company), and accessed by the vendor company. In the context of building a security score, the use of an API to share information may be advantageous because it allows for continuous data sharing and analysis to ensure the most up-to-date security score possible for a vendor company.

In some embodiments, the one or more processors 104 may request data from the company data source 130 using the API. This may occur on a regular basis as discussed above or may occur as needed by the computing device 102 to update the security score for a vendor company. This may include new vulnerabilities being discovered and the processor 104 may request information relating to the application version being run by the vendor company.

It should be understood that the analysis may use other data beyond that from a vendor company, such as third-party data from application, software, data, cloud, or artificial intelligence providers or compliance/regulatory bodies. This may be useful for the analysis to have the latest information related to vulnerabilities and potential solutions to those vulnerabilities to provide the most accurate security score possible.

Security marketplace 160 may be a third-party computing platform that serves as an analysis platform to evaluate a vendor company's security practices without the vendor company having to send their company data 136 or 146 to an organization. This allows the company data 136 or 146 to not be directly exposed to an organization if it so wishes. Security marketplace 160 may include one or more processors 162 such as one or more microprocessors, controllers, and/or any other suitable type of processor. The security marketplace 160 may further include a memory 164 (e.g., volatile memory, non-volatile memory) accessible by the one or more processors 162 (e.g., via a memory controller). The one or more processors 162 may interact with the memory 162 to obtain and execute, for example, computer-readable instructions stored in the memory 164. Additionally or alternatively, computer-readable instructions may be stored on one or more removable media (e.g., a compact disc, a digital versatile disc, removable flash memory, etc.) that may be coupled to the security marketplace 160 to provide access to the computer-readable instructions stored thereon. In particular, the computer-readable instructions stored on the memory 164 may include instructions for executing various applications. The security marketplace 160 may further include display 166.

A central repository 120 may also be used for storing security scores for one or more vendor companies. In this way, security scores for a plurality of vendor companies, such as companies that provide similar services, are available to an organization so that the organization may have more information for decision making purposes. The central repository 120 may also serve as a clearinghouse that allows multiple organizations to view security scores for multiple vendor companies. In other embodiments, the central repository 120 may only be accessible to computing device 102.

The central repository 120 may include one or more processors 104 such, as one or more microprocessors, controllers, and/or any other suitable type of processor. The central repository 120 may further include a memory 124 (e.g., volatile memory, non-volatile memory) accessible by the one or more processors 122 (e.g., via a memory controller). The one or more processors 122 may interact with the memory 124 to obtain and execute, for example, computer-readable instructions stored in the memory 124. Additionally or alternatively, computer-readable instructions may be stored on one or more removable media (e.g., a compact disc, a digital versatile disc, removable flash memory, etc.) that may be coupled to the central repository 120 to provide access to the computer-readable instructions stored thereon. In particular, the computer-readable instructions stored on the memory 124 may include instructions for executing various applications. In some embodiments, the central repository 120 may perform the analysis and determine security scores that are then available for use by one or more organizations.

In operation, an artificial intelligence (AI) or machine learning (ML) training application that may be stored in the memory of computing device 102, vendor security marketplace 160, or central repository 120 may train a security score ML algorithm. For example, as will be described elsewhere herein, an AI or ML training application may receive historical data using a company data source API into the AI or ML algorithm to train the security score ML algorithm.

In addition, further regarding the example system 100, the illustrated exemplary components may be configured to communicate, e.g., via a network 180 (which may be a wired or wireless network, such as the internet), with any other component. Furthermore, although the example system 100 illustrates only one of each of the components, any number of the example components are contemplated (e.g., any number of computing devices, company data sources, etc.).

### Exemplary Displays

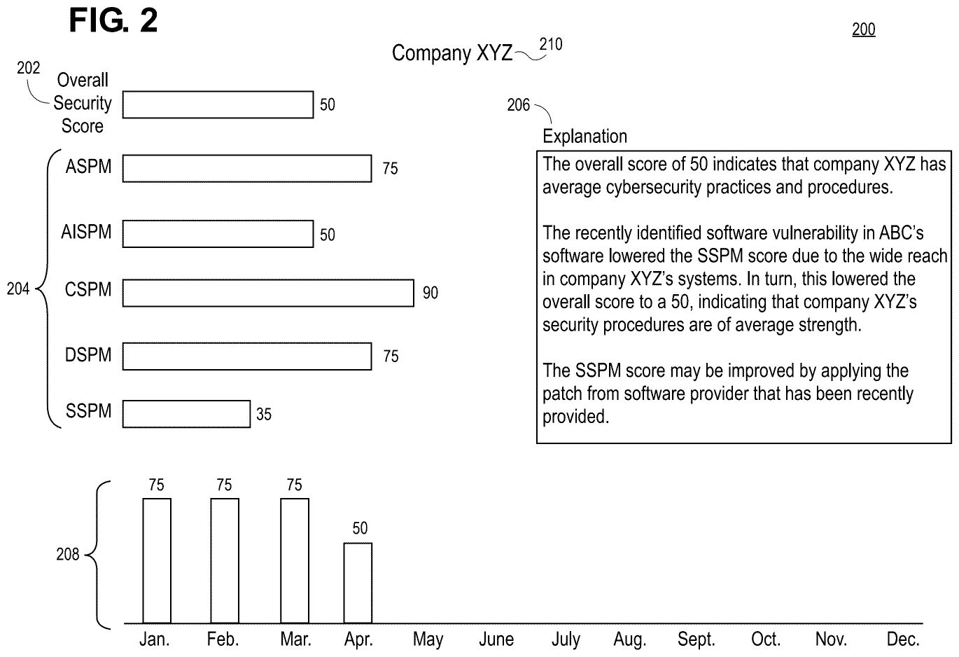

FIG. 2 depicts an example message screen 200 of a company's security score that may be displayed, along with other supporting information. Element 202 shows the overall security score for a particular vendor company, named here as “Company XYZ” in element 210. Below the overall security score, a display of the individual components of the security score is listed in element 204. The individual components of the security score may include any or all of the following security posture techniques: Application Security Posture Management (ASPM), Artificial Intelligence Security Posture Management (AISPM), Cloud Security Posture Management (CSPM), Data Security Posture Management (DSPM), Software as a Service Security Posture Management (SSPM), and/or other security posture management. Each SPM area is related to a unique technique for evaluating its security posture.

Cloud Security Posture Management (CSPM) refers to the process of monitoring cloud-based systems and infrastructures for risks and misconfigurations. CSPM may be particularly important for organizations that use public cloud infrastructure.

Application Security Posture Management (ASPM) refers to the process of evaluating, managing, and enhancing the security stance of an organization's custom applications. ASPM assesses all applications and app components for threats, misconfigurations, and non-compliance violations. ASPM tools also may scan software development, testing, and CI/CD pipelines for code-level vulnerabilities, leaked secrets, etc.

Data Security Posture Management (DSPM) refers to monitoring and assessing an organization's data across various environments to identify potential vulnerabilities, misconfigurations, and risks, allowing security teams to proactively protect sensitive data from unauthorized access, misuse, or theft.

Software as a Service Security Posture Management (SSPM) refers to identifying security risks in software-as-a-service (SaaS) applications.

Artificial Intelligence Security Posture Management (AISPM) focuses on identifying and fixing vulnerabilities in AI models, data, and infrastructure. AI vulnerabilities may include unsafe model usage or misconfiguration that compromises privacy and exposes an organization's private information.

Element 206 includes an area where the security score may be explained or where the greatest factors contributing to the determination are listed. In one example, if a new and widespread vulnerability has been identified in software security, this can be listed in element 206, along with potential solutions to the vulnerability, if such exist at the time. Additionally or alternatively, box 206 may display: (i) a suggestion of how to use the vendor securely (e.g., a suggestion to use a VPN, a particular type of encryption, etc.), and/or (ii) an explanation of how the company can improve security of the vendor should the company decide to work with the vendor (e.g., as in the illustrated example, apply a patch from a software provider). In some embodiments, the explanation 206 is determined by a generative AI chatbot.

Element 208 includes a historical display of a vendor company's security score. In this example, the score is listed monthly, but the time period may be any appropriate time period, such as days, hours, weeks, or others. This gives the organization an indication of how a particular vendor company has performed in terms of security over time and may be used to give more context to the current overall security score. For example, a company with historically low security scores that suddenly improves may be indicative of a company that is making an effort to improve security practices.

The overall security score may account for any number of the above techniques, focusing on one or more of them at a time, such as using CSPM and DSPM techniques together to determine an overall security score for a vendor company. The security score may be determined by weighting the various techniques according to any criteria, including the needs of the organization, by using an attention model and biasing the security score towards vulnerabilities that are determined to be more critical by the attention model. For example, if a vulnerability related to cloud security has been identified that is identified by the attention model to be of high importance, the overall security score may be biased towards weighting the cloud security posture management portion greater when determining an overall security score.

In technical terms, an attention model assigns different weights to various parts of the input data. These weights determine how much focus or “attention” the model should give to each part when processing the data. For example, in processing a sentence, the model might pay more attention to nouns or specific keywords that are crucial for understanding the sentence's meaning. In the context of building a security score, a weight may be applied to different security risks related to various vendor company vulnerabilities and may be used to indicate the relative severity of different vulnerabilities. For example, not encrypting data may be weighed more than not requiring two factor authentication for user login, which may advantageously indicate that unencrypted data is the more serious vulnerability.

The model uses these weights to selectively enhance the important parts of the data and diminish the less relevant parts, making it easier to perform tasks. This approach helps improve the accuracy and efficiency of the model by mimicking how humans tend to focus on the most pertinent information when learning or making decisions.

The attention model for assessing cybersecurity is a strategic approach to focusing on the most critical security areas in an organization. By assessing the threat landscape, risk factors, and effectiveness of existing controls, organizations can direct their resources more efficiently, prioritize high-risk assets, and reduce the likelihood of successful attacks. This model emphasizes the dynamic nature of cybersecurity and the need for ongoing, targeted attention to evolving threats and risks. By using an attention model as part of the security score determination and biasing the determination towards more immediate or grave vulnerabilities, the overall security score may be dynamic and up to date with the most current cybersecurity risks and solutions.

An organization may not necessarily wish to choose the highest overall security score, although in many cases that may be the best choice. For example, an organization might not be using artificial intelligence extensively, so that portion of the overall security score may not be as important to the organization. For this reason, the security score weights may be adjusted by the organization that is using the security score to reflect their particular use case. This allows the security score to be flexible and customizable to an organization's needs.

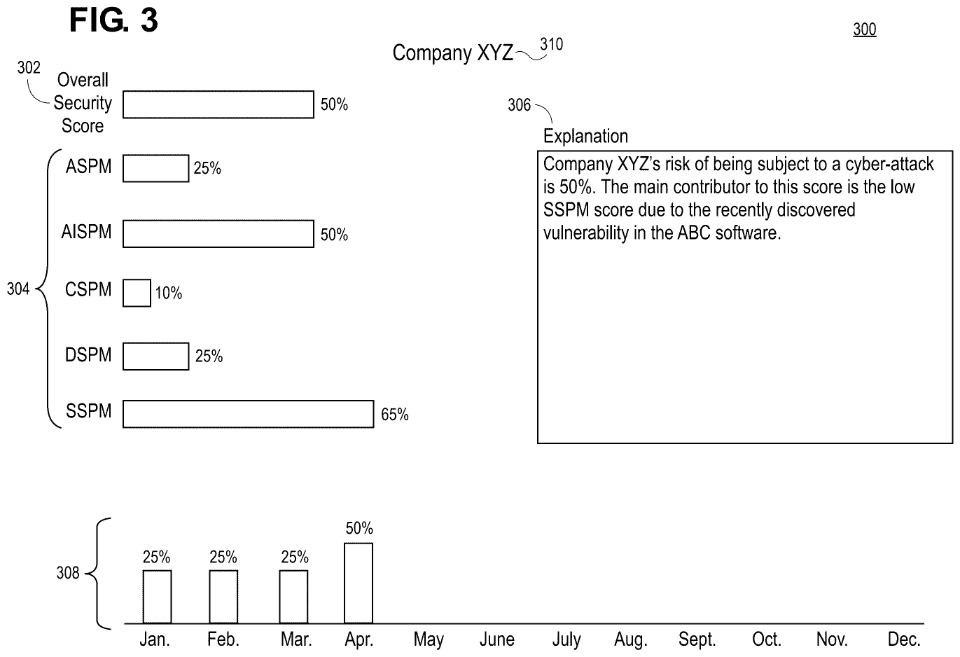

FIG. 3 depicts the risk percentage for a vendor company, indicating an estimate of the chances that the company will be affected by a cyberattack. From this perspective, a lower score is better than a higher score because it indicates a company is unlikely to be subject to an adverse cybersecurity event.

Similar to the elements of FIG. 2, FIG. 3 includes a company name 310, explanation area 306, and a historical display of a vendor company's risk percentage 308. Additionally or alternatively to the illustrated example, box 306 may display: (i) a suggestion of how to use the vendor securely (e.g., a suggestion to use a VPN, a particular type of encryption, etc.), and/or (ii) an explanation of how the company can improve security of the vendor should the company decide to work with the vendor (e.g., apply a patch from a software provider). In some embodiments, the explanation 306 is determined by a generative AI chatbot.

The risk percentage 302 for a company may be calculated similarly to the security score 202, but may also be weighted differently than the security score by biasing the determination more towards vulnerabilities and less towards security practices. Element 304 includes risk percentages for individual categories of cybersecurity posture management.

The risk percentage of a company experiencing a cyberattack may be affected by many factors, such as password reuse practices, software code vulnerabilities (e.g., zero-day vulnerabilities), or unpatched software. As such, the determined risk percentage may change quickly due to changes in a company's practices or by fixing identified vulnerabilities. In the example illustrated in FIG. 3, the overall risk percentage for a particular vendor company is 50%, which could represent an average risk of experiencing a cyber-attack. In this context, a higher risk percentage, such as 80%, would indicate that a vendor company is relatively more likely to experience a cyber-attack than a lower risk percentage.

This risk percentage may be updated continuously or at set intervals, such as hourly, daily, weekly, or any other set time period. Continuous updating may offer the advantage of a consistently up to date security score that includes all currently known factors that can affect the security score.

### Exemplary Computer-Implemented Method for Building a Security Score for a Company

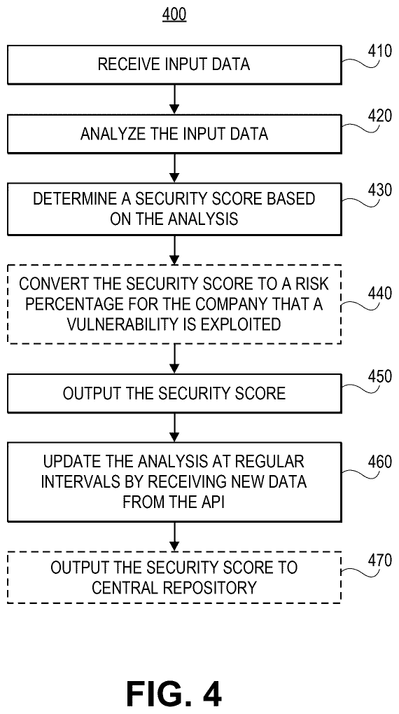

FIG. 4 illustrates a flow diagram representing an exemplary computer-implemented method or implementation 400 for building a security score for a company. The method 400 may be implemented by a computing environment 100, for example, including the computing device 102, the central repository 120, and/or any suitable device including those discussed elsewhere herein, such as one or more local or remote processors, transceivers, memory units, mobile devices, etc. For purposes of illustration, computing device 102 will be used here.

At block 410, input data is received by processor 104 using an API. The input data may be anonymized by the vendor company before sending so that an organization only sees the results of the analysis and not the full data. Alternatively, the input data may be anonymized as part of the analysis, for example by a cloud computing platform that hosts a vendor company's operations. The input data may be collected by a third party, such as vendor security marketplace 160, which may be a cloud services provider or compliance/regulatory body. In some embodiments, this may be an independent organization for determining security scores. This may be advantageous because a vendor company would not have to share their data with every organization for building a security score and may keep identifying information private.

The input data may include system configuration data, such as details about firewall rules, server configurations, or access controls; compliance audit reports, such as adherence to relevant security standards and regulations; user access information, such as details about user accounts, permissions, and login activities; log data, such as system logs from various sources like network devices, applications, and security tools; cloud service usage data, including information about cloud infrastructure configurations, resource usage, and security settings within cloud platforms; and data classification details, including identifying sensitive data types and their locations within the organization; or other types of data, such as metadata.

At block 420, the input data is analyzed by processor 104 using a first technique, such as a CSPM, ASPM, DSPM, AISPM, or SSPM, and/or also includes applying a weight for different vulnerabilities. As discussed above with respect to FIG. 2, the weight may be determined using an attention model and by biasing the security score towards vulnerabilities that are determined to be more critical by the attention model. The weight is a parameter that the model learns during training. It is applied to input features to determine how much influence the input has on the output. Biases are constant values that are added to the product of the inputs and weights. They allow the model to adjust the output independently of the input features. During training, the model adjusts the weights and biases to increase the accuracy of predictions.

At block 430, a security score is determined by processor 104 based on the analysis performed at block 420. The security score may be determined using an AI or ML model that is trained using historical data relating to security vulnerabilities and security practices, such as timely application of software patches.

At optional block 440, the security score may be converted to a risk percentage for the company that a vulnerability is exploited. For example, if the analysis performed in block 420 identifies a vulnerability related to data security, that information may be used as part of determining a security score where the more critical the vulnerability is, the higher the risk that the vulnerability will be exploited.

At block 450, the security score is output by processor 104. As illustrated in FIG. 1, the security score may, for example, be output to one or more of a central repository 120, a vendor security marketplace 160, or a computing device 102.

At block 460, the analysis may be updated by processor 104 by receiving new input data from the API. The update may be performed at regular intervals, such as daily, weekly, or monthly, but may also occur outside of a defined time frame, such as after a vulnerability is discovered. For example, if a major vulnerability is found 2.5 weeks after the last security score update, a new security score may be generated to take the new information into account for the analysis. In addition, the analysis may be continuously performed, where the method repeats after block 450 each time, resulting in the most up to date security score possible.

At optional block 470, the security score may be outputted to a central repository 120. This allows the security score to be saved for use in the future or by several organizations. Saving security scores for several vendor companies allows for organizations to compare security scores across an industry or sector to easily assess which company fits their needs best.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary AI and/or ML Techniques

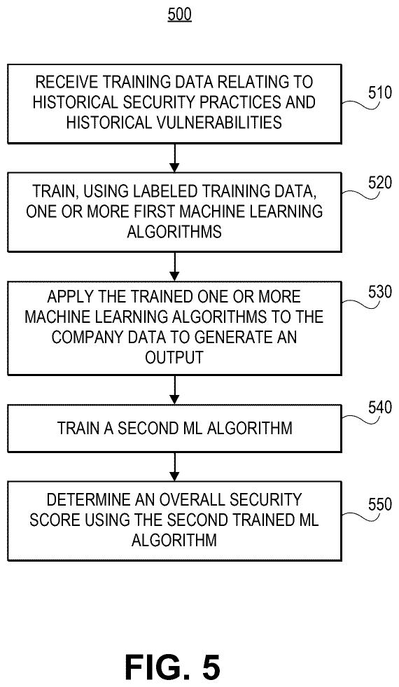

FIG. 5 depicts an example flowchart for training and deploying an AI/ML model for determining security scores. Although the following discussion refers to ML models, it should be understood that the model may additionally or alternatively be an AI model (e.g., the following discussion applies equally to an AI and/or ML model).

At block 510, training data may be received at the one or more processors 104. The training data may be related to historical vulnerabilities and historical security practices. Security vulnerabilities refer to weaknesses or flaws in a system that can be exploited by malicious actors to gain unauthorized access, cause damage, or disrupt operations. Example historical security vulnerabilities may include allowing password reuse or sharing, timely patching of software applications, user authentication or validation practices, security settings relating to firewalls and access control lists, or unencrypted communications. Example historical security practices that may be used to train the ML algorithm may include password management, such as multi-factor authentication, regular software updates, use of antivirus and or anti-malware software, security awareness training for users and employees, the development of an incident response plan, and others. This list is for example only, it should be understood that there may be other security practices and vulnerabilities that may be used as training data for a ML algorithm related to determining security scores. The training data may also include historical: overall security scores, CSPM scores, ASPM scores, DSPM scores, SSPM scores, and/or AISPM scores which correspond to the historical vulnerabilities and historical security practices.

In some examples, the training data comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the security scores that the ML algorithm is trained to determine; and the independent variables (e.g., historical vulnerabilities, historical security practices, etc.) are used to determine the dependent variables (e.g., historical: overall security scores, CSPM scores, ASPM scores, DSPM scores, SSPM scores, and/or AISPM scores). Put another way, the independent variables may have an impact on the dependent variables; and the ML algorithms may be trained to find this impact. Therefore, when using a trained ML algorithm to determine a security score, information corresponding to the training data information that the ML was trained on may be routed into the ML algorithm to determine the insight score. For example, historical vulnerabilities (e.g., from the training data received at block 510), historical security practices, etc., may be input into the trained ML algorithm to determine the overall security score and/or any of the CSPM, ASPM, DSPM, SSPM, and/or AISPM scores.

Similarly, the attention model may be trained using the training data along with the ML algorithm. In this way, the attention model may be optimized to find the most relevant aspects for any of CSPM, ASPM, DSPM, SSPM, and/or AISPM. In other words, the attention model may learn different important aspects for each of CSPM, ASPM, DSPM, SSPM, and/or AISPM, depending on what is most appropriate for the organization.

At block 520, a first ML algorithm is trained using the training data related to (1) historical (i) security vulnerabilities and (ii) security practices as independent variables; and (2) historical scores for CSPM, ASPM, DSPM, SSPM, and/or AISPM as dependent variables. As described above, the training data may be labeled as examples of strong security practices and weak security practices and the historical vulnerability data may be labeled according to its perceived severity. For example, a vulnerability related to unencrypted communications may be labeled as more severe than a vulnerability related to weak firewall settings. It should be understood that the training data may receive different labels for different areas of cybersecurity, such as CSPM and ASPM.

At block 530, the trained ML algorithm may be applied to company data received using an API. This block may correspond to block 420 of FIG. 4 where the input data is analyzed. The first trained ML algorithm may then use security practices and vulnerability data to output CSPM, ASPM, DSPM, SSPM, and/or AISPM values.

At block 540, a second ML algorithm may be trained using (1) historical CSPM, ASPM, DSPM, SSPM, and/or AISPM scores as independent variables; and (2) historical overall scores as dependent variables.

At block 550, the trained second ML algorithm determines an overall security score for a vendor company based on input CSPM, ASPM, DSPM, SSPM, and/or AISPM values. Security scores may be determined using the ML algorithm and based on user-generated information and system-generated information associated with security vulnerabilities and practices.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for building a security score for a company, comprising:
receiving, via one or more processors, input data using an application programming interface (API);
analyzing, via the one or more processors, the input data according to at least a first technique including applying weights to different vulnerabilities, wherein the weights are determined using an attention model and by biasing the security score towards vulnerabilities that are determined to be more critical by the attention model;
determining, via the one or more processors, a security score based on the analysis;
outputting, via the one or more processors, the security score; and
updating, via the one or more processors, the analysis by collecting new input data using the API.

2. The computer-implemented method of claim 1, wherein the first technique is a security posture management technique.

3. The computer-implemented method of claim 1, wherein the first technique is one of cloud security posture management (CSPM), SaaS security posture management (SSPM), data security posture management (DSPM), application security posture management (ASPM), artificial intelligence security posture management (AISPM), and/or other security posture management.

4. The computer-implemented method of claim 3, wherein:
the analyzing further comprises analyzing the input data according to a second technique, wherein the second technique is another of the CSPM, SSPM, DSPM, ASPM, or AISPM.

5. The computer-implemented method of claim 3, wherein:
the analyzing further comprises analyzing the input data according to a third, fourth, or fifth technique, wherein the third, fourth, or fifth technique is another of the CSPM, SSPM, DSPM, ASPM, or AISPM.

6. The computer-implemented method of claim 1, wherein the input data is collected by a third party.

7. The computer-implemented method of claim 1, wherein a weight for a particular vulnerability is determined by a likelihood that the particular vulnerability can be exploited or if the particular vulnerability has been exploited.

8. The computer-implemented method of claim 1, further comprising:
training, by the one or more processors, one or more machine learning algorithms by inputting, into the one or more machine learning algorithms, labeled training data including data indicative of historical: (i) security vulnerabilities and (ii) security practices; and
wherein the first technique further includes applying the trained one or more machine learning algorithms to the input data.

9. The computer-implemented method of claim 1, wherein the collecting the new input data includes the API calling a cloud database.

10. The computer-implemented method of claim 1, wherein the input data is metadata relating to one or more of cloud security, data security, application security, SaaS security, or artificial intelligence security.

11. The computer-implemented method of claim 1, wherein the security score is output to a display device.

12. The computer-implemented method of claim 1, further including, via the one or more processors, outputting the security score to a central repository.

13. The computer-implemented method of claim 1, further including converting, via the one or more processors, the security score for a company to a risk percentage that a vulnerability is exploited.

14. A computing system for building a security score for a company, comprising:
one or more processors;
a non-transitory computer-readable medium coupled to the one or more processors and a communication unit and storing instructions thereon that, when executed by the one or more processors, cause the computing system to:
receive input data using an application programming interface (API);
analyze the input data according to at least a first technique including applying weights to different vulnerabilities, wherein the weights are determined using an attention model and by biasing the security score towards vulnerabilities that are determined to be more critical by the attention model;
determine a security score based on the analysis;
output the security score; and
update the analysis by collecting new input data using the API.

15. The computing system of claim 14, wherein the first technique is a security posture management technique.

16. The computing system of claim 14, wherein the first technique is one of cloud security posture management (CSPM), SaaS security posture management (SSPM), data security posture management (DSPM), application security posture management (ASPM), or artificial intelligence security posture management (AISPM), and/or other security posture management.

17. The computing system of claim 16, wherein:
the analyzing further comprises analyzing the input data according to a second technique, wherein the second technique is another of the CSPM, SSPM, DSPM, ASPM, or AISPM.

18. The computing system of claim 14, wherein the input data is collected by a third party.

19. The computing system of claim 18, wherein the input data is anonymized before the security score is determined.

20. The computing system of claim 14, wherein a weight for a particular vulnerability is determined by a likelihood that the particular vulnerability can be exploited or if the particular vulnerability has been exploited.

21. The computing system of claim 14, wherein the input data is received from a vendor, and wherein the instructions, when executed by the one or more processors, further cause the computing system to:
determine, with a generative artificial intelligence (AI) chatbot: (i) a suggestion of how to use the vendor securely, and/or (ii) an explanation of how the company can improve security of the vendor should the company decide to work with the vendor.
